(19) United States
(12) Patent Application Publication
(10) Pub. No.: US 2024/0424442 A1
(43) Pub. Date: Dec. 26, 2024

(54) METHOD AND APPARATUS FOR SUSTAINABLE CARBON DIOXIDE SEQUESTRATION

(71) Applicant: GarboCarbo Inc., Palatine, IL (US)

(72) Inventors: Pavan Venkatesh Pandurangi, Palatine, IL (US); Shashwat Subramaniam Viswanath, Fullerton, CA (US); Kevin Xueyang Han, Palatine, IL (US)

(21) Appl. No.: 18/752,010

(22) Filed: Jun. 24, 2024

Related U.S. Application Data
(60) Provisional application No. 63/509,675, filed on Jun. 22, 2023.

(51) Int. Cl. B01D 53/62; B01D 53/14; B01D 53/18; B01D 53/73; B01D 53/77

(52) U.S. Cl. CPC B01D 53/62; B01D 53/1425; B01D 53/1493; B01D 53/18; B01D 53/73; B01D 53/77; B01D 2251/304; B01D 2251/306; B01D 2251/404; B01D 2251/604; B01D 2251/606; B01D 2257/504

(57) ABSTRACT

An apparatus includes a first chamber, a second chamber, and a third chamber. The first chamber includes an alkaline solution, a gas inlet to receive carbon dioxide-containing gas, and a gas outlet. The first chamber outputs a solution containing a first metal carbonate containing a first metal to the second chamber via a first channel, and the second chamber outputs a solution containing a first metal hydroxide containing the first metal to the first chamber via a second channel. The third chamber is configured to perform an electrochemical reaction to convert a mineral containing a second metal to a second metal hydroxide containing the second metal. The third chamber is coupled to the second chamber via a third channel and outputs the second metal hydroxide containing the second metal to the second chamber via the third channel.

### CROSS-REFERENCE TO RELATED APPLICATIONS

The application claims priority to and benefits of Provisional Patent Application No. 63/509,675 filed on Jun. 22, 2023. The entire content of the above-referenced application is incorporated herein by reference.

### TECHNICAL FIELD

This disclosure is generally related to methods and apparatuses for sustainably sequestrating carbon dioxide.

### BACKGROUND

Carbon dioxide has been linked to global warming and possible climate change. Many technologies have been proposed reduce the emission of carbon dioxide into the air. Recently, electric vehicles with zero carbon dioxide emission have gain market attraction. More and more consumers have opted to adapt new technologies to reduce the pace of producing more carbon dioxide into the air.

Several carbon dioxide sequestration technologies are emerging. One of them is to use calcium hydroxide to capture carbon dioxide. However, the technology has not been optimized for better performance.

### SUMMARY

Described herein are methods and apparatuses for sustainably capturing and sequestrating carbon dioxide.

In one aspect, an apparatus is provided. The apparatus includes a first chamber, a second chamber, and a third chamber. The first chamber includes an alkaline solution, a gas inlet to receive carbon dioxide-containing gas, and a gas outlet, where a carbon dioxide concentration at the gas out is lower than a carbon dioxide concentration at the gas inlet. The second chamber is coupled with the first chamber by a first channel and a second channel. The first chamber outputs a solution containing a first metal carbonate containing a first metal to the second chamber via the first channel, and the second chamber outputs a solution containing a first metal hydroxide containing the first metal to the first chamber via the second channel. The third chamber is configured to perform an electrochemical reaction to convert a mineral containing a second metal to a second metal hydroxide containing the second metal. The third chamber is coupled to the second chamber via a third channel and outputs the second metal hydroxide containing the second metal to the second chamber via the third channel. The second chamber is configured to perform a reaction to convert the first metal carbonate containing the first metal and the second metal hydroxide containing the second metal to the first metal hydroxide containing the first metal and a second metal carbonate containing the second metal.

In some embodiments, the first metal comprises a group I metal.

In some embodiments, the first metal comprises K or Na.

In some embodiments, the first metal carbonate comprises K₂CO₃ or Na₂CO₃.

In some embodiments, the first metal hydroxide comprises KOH or NaOH.

In some embodiments, the second metal comprises a group II metal.

In some embodiments, the second metal comprises Ca or Mg.

In some embodiments, the second metal carbonate comprises CaCO₃ or MgCO₃.

In some embodiments, the second metal hydroxide comprises Ca(OH)₂ or Mg(OH)₂.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 is diagram illustrating an apparatus for sustainably sequestrating carbon dioxide, according to one example embodiment.

FIG. 2 is diagram illustrating an apparatus for sustainably sequestrating carbon dioxide, according to another example embodiment.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Various embodiments described herein are directed to methods and apparatuses for sustainably sequestrating carbon dioxide.

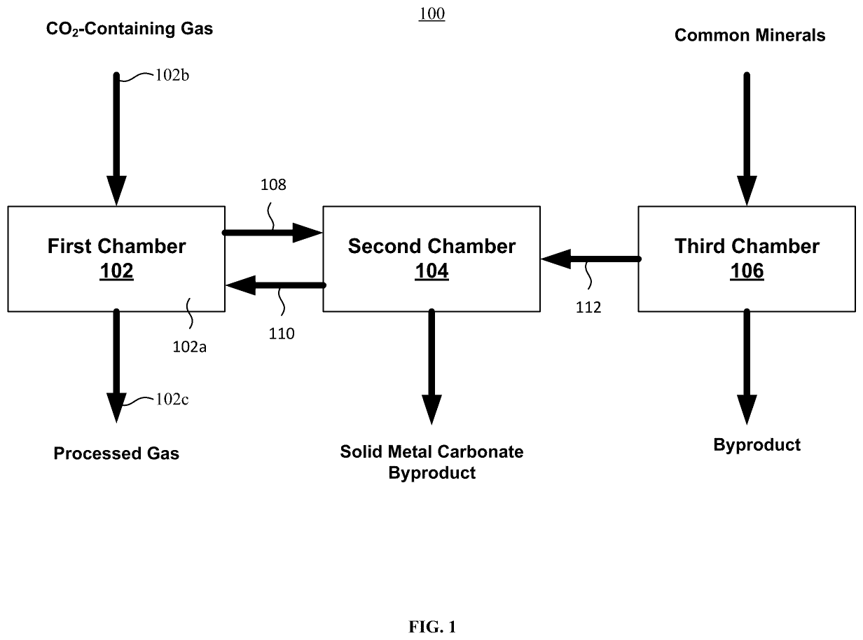

Reference is first made to FIG. 1. FIG. 1 shows an apparatus 100 for sustainably sequestrating carbon dioxide. The apparatus 100 includes a first chamber 102, a second chamber 104, and a third chamber 106. The apparatus 100 further includes a first channel 108 and a second channel 110 coupled between the first chamber 102 and the second chamber 104. The apparatus 100 further includes a third channel 112 coupled between the second chamber 104 and the third chamber 106.

The first chamber 102 includes an alkaline solution 102a, a gas inlet 102b to receive carbon dioxide-containing gas, and a gas outlet 102c to receive processed gas. After the carbon dioxide-containing gas is processed in the first chamber 102 where the carbon dioxide is sequestered, a carbon dioxide concentration at the gas out 102c is lower than a carbon dioxide concentration at the gas inlet 102b. In the first chamber 102, the carbon dioxide is sequestered in the alkaline solution 102a. In some embodiments, the alkaline solution has a pH value of equal to or greater than 13. For example, the alkaline solution may be prepared by adding one or more alkalis into water. To produce an alkaline solution having a pH values of equal to or greater than 13, the alkalis may be one or more of potassium hydroxide, sodium hydroxide, ammonium hydroxide, etc. In some embodiments, the alkaline solution contains no ammonium hydroxide to obtain a high pH value equal to or greater than 13. In some embodiments, the alkaline solution contains no sodium hydroxide to obtain a high pH value equal to or greater than 13. Still in some embodiments, the alkaline solution contains no ammonium hydroxide and sodium hydroxide to obtain a high pH value equal to or greater than 13. In some embodiments, the alkaline solution contains only potassium hydroxide to obtain a high pH value equal to or greater than 13. In some embodiments, the alkaline solution is prepared at room temperature (e.g., 20-45° C.).

The first chamber 102 receives the carbon dioxide-containing gas from the gas inlet 102b. The source for the carbon dioxide-containing gas may be air, flue gas, or concentrated carbon dioxide, which is not particularly limited. After the carbon dioxide is sequestered, the processed gas that has a carbon dioxide concentration lower than a carbon dioxide concentration of the source gas is output at the gas outlet 102c. The carbon dioxide sequestration turns the original alkaline solution 102a into a solution that contains a first metal carbonate, where the first metal comprises a group I metal, such as K or Na. The first metal carbonate is communicated to the second chamber 104 via the first channel 108. In some embodiments, the first metal carbonate includes K₂CO₃ or Na₂CO₃.

In parallel, the third chamber 106 is provided with common minerals found on earth for an electrochemical reaction to convert one or more minerals into one or more metal hydroxides. For example, the minerals input to the third chamber 106 may include calcium sulfate (CaSO₄) and/or magnesium sulfate (MgSO₄). The electrochemical reaction in the third chamber 106 may be bipolar membrane electrodialysis. For example, calcium sulfate reacts with NaOH or other alkaline to make Ca(OH)₂ and Na₂SO₄. The electrochemical reaction with bipolar membrane electrodialysis re-synthesizes NaOH by splitting the generated Na₂SO₄ into NaOH and H₂SO₄. The output of the third chamber is Ca(OH)₂ and sulfuric acid. In general, the reaction may produce at least one metal hydroxide (e.g., Ca(OH)₂ or Mg(OH)₂) (second metal hydroxide) that is provided to the second chamber 106 via the third channel 112. The electrochemical reaction in the third chamber 106 may also produce a byproduct such as H₂SO₄, which may be collected for industrial use.

The second chamber 104 receives the first metal carbonate from the first chamber 102 from the first channel 108 and the one or more metal hydroxides from the third chamber 106 via the third channel 112. The first metal carbonate and the one or more metal hydroxides are reacted in the second chamber 104 to generate at least a first metal hydroxide and a second metal carbonate. The first metal hydroxide is provided back to the first chamber 102 via the second channel 110 as the alkaline solution for use in the reaction in the first chamber 102. The second metal carbonate is allowed to precipitate into solid mass and can be collected for industrial use. In some embodiments, the first metal carbonate from the first chamber 102 may include K₂CO₃ or Na₂CO₃ and the second metal hydroxide from the third chamber 106 may include Ca(OH)₂ or Mg(OH)₂. The reaction in the second chamber 104 converts the first metal carbonate (e.g., K₂CO₃ or Na₂CO₃) and the second metal hydroxide (e.g., Ca(OH)₂ or Mg(OH)₂) to the first metal hydroxide (e.g., KOH or NaOH) and a second metal carbonate (e.g., CaCO₃ or MgCO₃).

The first metal hydroxide generated in the second chamber can be re-used in the first chamber to continue sequestering carbon dioxide, creating a sustainable sequestration system that does not require constant refill of the alkaline solution. The byproducts from the apparatus 100, such as, H₂SO₄ and metal carbonate (e.g., CaCO₃ or MgCO₃) can be collected for other industrial uses. The inputs to the disclosed sequestration system are carbon dioxide-containing gas and low-cost common minerals found on earth, resulting in a low cost carbon dioxide sequestration system. It also overcomes the deficiencies of conventional carbon dioxide sequestration system, where it needs steady inflow of the metal hydroxide in the sequestering reaction that is very expensive.

In some embodiments, before the carbon dioxide is introduced to the alkaline solution, the alkaline solution has a pH value of 13, 13.1, 13.2, 13.3, 13.4, 13.5, 13.6, 13.7, 13.8, 13.9, and 14, or between any two numbers of the above values. To obtain a faster sequestration, in some embodiments, the pH value of the alkaline solution before the carbon dioxide is introduced is about 13.7, 13.8, 13.9, and 14, or between any two numbers of these values.

The flow rate of the carbon dioxide into the alkaline solution is controlled to provide faster reaction. A faster reaction is one where the pH value is neutralized to approximately 7.0 and/or where temperature peaks within a shorter time span.

For example, the carbon dioxide is introduced into the alkaline solution at a flow rate greater than 0.25 L/minute. In some embodiments, to provide even faster reaction, the carbon dioxide is introduced into the alkaline solution at a flow rate greater than 0.30, 0.35, 0.40, 0.45, 0.50 L/minute. In some embodiments, the carbon dioxide is introduced into the alkaline solution at a flow rate no greater than 0.50 L/minute to prevent lowering the sequestration efficiency. In some embodiments, the carbon dioxide is introduced into the alkaline solution at a flow rate no greater than 0.60 L/minute to prevent lowering the sequestration efficiency. In some embodiments, the carbon dioxide is introduced into the alkaline solution at a flow rate no greater than 0.70 L/minute to prevent lowering the sequestration efficiency. In some embodiments, the carbon dioxide is introduced into the alkaline solution at a flow rate no greater than 0.80 L/minute to prevent lowering the sequestration efficiency. In some embodiments, the carbon dioxide is introduced into the alkaline solution at a flow rate no greater than 0.90 L/minute to prevent lowering the sequestration efficiency. In some embodiments, the carbon dioxide is introduced into the alkaline solution at a flow rate no greater than 1 L/minute to prevent lowering the sequestration efficiency.

In some embodiments, the flow rate of the carbon dioxide may be increased to about 1.9×10¹⁰ L/minute.

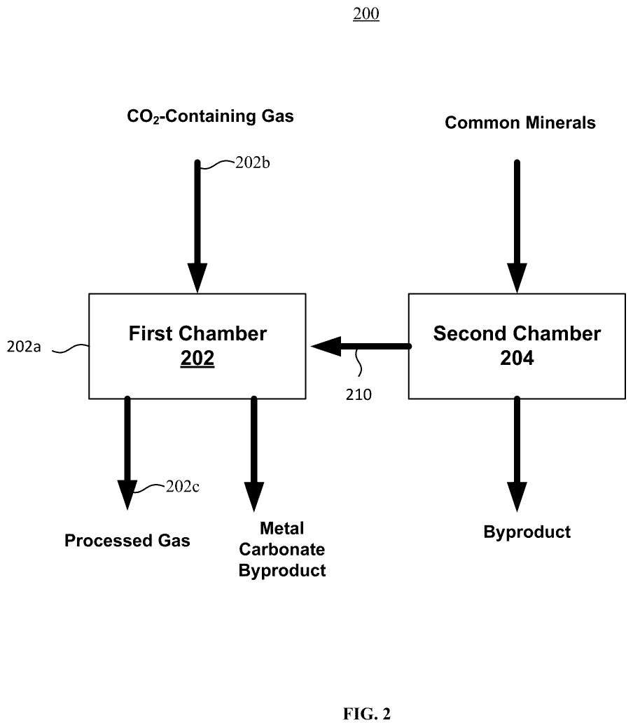

Reference is now made to FIG. 2. FIG. 2 shows an apparatus 200 for sustainably sequestrating carbon dioxide according to one example embodiment. The apparatus 200 includes a first chamber 202 and a second chamber 204. The apparatus 200 further includes a first channel 210 coupled between the second chamber 204 and the first chamber 202.

The first chamber 202 includes a metal hydroxide solid 202a, a gas inlet 202b to receive carbon dioxide-containing gas, and a gas outlet 202c to receive processed gas. After the carbon dioxide-containing gas is processed in the first chamber 202 where the carbon dioxide is sequestered with the metal hydroxide solid 202a, a carbon dioxide concentration at the gas outlet 202c is lower than a carbon dioxide concentration at the gas inlet 202b. In the first chamber 202, the carbon dioxide is sequestered in the metal hydroxide solid 202a. In some embodiments, the metal hydroxide solid 202a may be micro- or nano-particles of one or more metal hydroxides, such as calcium hydroxide or magnesium hydroxide. The metal hydroxide solid 202a may be placed on a tray or a fixed bed reactor. The metal hydroxide solid reacts with the carbon dioxide in the ambient (or concentrated) gas stream and transforms into the corresponding metal carbonate (byproduct), such as CaCO₃ or MgCO₃.

The first chamber 202 receives the carbon dioxide-containing gas from the gas inlet 202b. The source for the carbon dioxide-containing gas may be air, flue gas, or concentrated carbon dioxide, which is not particularly limited. After the carbon dioxide is sequestered, the processed gas that has a carbon dioxide concentration lower than a carbon dioxide concentration of the source gas is output at the gas outlet 202c.

In parallel, the second chamber 204 is provided with common minerals found on earth for an electrochemical reaction to convert one or more minerals into one or more metal hydroxides. For example, the minerals input to the second chamber 204 may include calcium sulfate (CaSO₄) and/or magnesium sulfate (MgSO₄). The electrochemical reaction in the second chamber 204 produces at least one metal hydroxide (e.g., Ca(OH)₂ or Mg(OH)₂) that is provided to the first chamber 202 via the first channel 210. The electrochemical reaction in the second chamber 204 may also produce a byproduct such as H₂SO₄, which may be collected for industrial use.

The byproducts from the apparatus 200, such as, H₂SO₄ and metal carbonate (e.g., CaCO₃ or MgCO₃) can be collected for other industrial uses. The inputs to the disclosed sequestration system are carbon dioxide-containing gas and low-cost common minerals found on earth, resulting in a low cost carbon dioxide sequestration system. It also overcomes the deficiencies of the conventional carbon dioxide sequestration system, where it needs to calcine the metal carbonate into metal oxide, carbon dioxide, and any unreacted metal hydroxide. The carbon dioxide released from the calcining would have to be transported and pressurized to be injected underground while the metal oxide is regenerated into metal hydroxide by submerging the metal oxide in water. The techniques disclosed in the embodiments above avoid these costly steps.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. An apparatus comprising:
a first chamber comprising an alkaline solution, a gas inlet to receive carbon dioxide-containing gas, and a gas outlet, wherein a carbon dioxide concentration at the gas outlet is lower than a carbon dioxide concentration at the gas inlet;
a second chamber coupled with the first chamber by a first channel and a second channel, wherein the first chamber outputs a solution containing a first metal carbonate containing a first metal to the second chamber via the first channel, and the second chamber outputs a solution containing a first metal hydroxide containing the first metal to the first chamber via the second channel; and
a third chamber configured to perform an electrochemical reaction to convert a mineral containing a second metal to a second metal hydroxide containing the second metal, wherein the third chamber is coupled to the second chamber via a third channel and outputs the second metal hydroxide containing the second metal to the second chamber via the third channel,
wherein the second chamber is configured to perform a reaction to convert the first metal carbonate containing the first metal and the second metal hydroxide containing the second metal to the first metal hydroxide containing the first metal and a second metal carbonate containing the second metal.

2. The apparatus of claim 1, wherein the first metal comprises a group I metal.

3. The apparatus of claim 2, wherein the first metal comprises K or Na.

4. The apparatus of claim 3, wherein the first metal carbonate comprises K₂CO₃ or Na₂CO₃.

5. The apparatus of claim 3, wherein the first metal hydroxide comprises KOH or NaOH.

6. The apparatus of claim 1, wherein the second metal comprises a group II metal.

7. The apparatus of claim 6, wherein the second metal comprises Ca or Mg.

8. The apparatus of claim 7, wherein the second metal carbonate comprises CaCO₃ or MgCO₃.

9. The apparatus of claim 7, wherein the second metal hydroxide comprises Ca(OH)₂ or Mg(OH)₂.

10. An apparatus comprising:
a first chamber comprising a metal hydroxide solid, a gas inlet to receive carbon dioxide-containing gas, and a gas outlet, wherein a carbon dioxide concentration at the gas outlet is lower than a carbon dioxide concentration at the gas inlet; and
a second chamber configured to perform an electrochemical reaction to convert a mineral containing a metal to the metal hydroxide solid, wherein the second chamber is coupled to the first chamber via a channel and outputs the metal hydroxide solid to the first chamber via the channel,
wherein the first chamber is configured to perform a reaction to convert the metal hydroxide solid to a metal carbonate.

11. The apparatus of claim 10, wherein the metal carbonate comprises CaCO₃ or MgCO₃.

12. The apparatus of claim 10, wherein the metal hydroxide solid comprises Ca(OH)₂ or Mg(OH)₂.
